(19) United States
(12) Patent Application Publication
(10) Pub. No.: US 2017/0259837 A1
(43) Pub. Date: Sep. 14, 2017

(54) Collapsible Cart Assembly

(71) Applicant: Gloria E. Arreola, Wauchula, FL (US)

(72) Inventor: Gloria E. Arreola, Wauchula, FL (US)

(21) Appl. No.: 15/068,694

(22) Filed: Mar. 14, 2016

(51) Int. Cl. B62B 3/02; B62B 3/10

(52) U.S. Cl. CPC B62B 3/02; B62B 3/106

(57) ABSTRACT

A collapsible cart assembly includes a base that may be rolled along a support surface. The base has a slidably adjustable width. The base may support an object thereby facilitating the object to be moved. A plurality of wheels is provided and each of wheels is removably coupled to and extends downwardly from the base. Each of the wheels rolls along the support surface. A pair of arches is provided and each of the arches is removably coupled to the base. A horizontal member is removably coupled between the arches. Thus, objects may be suspended from the horizontal member.

### BACKGROUND OF THE DISCLOSURE

### Field of the Disclosure

The disclosure relates to cart devices and more particularly pertains to a new cart device for use during travel thereby providing a wardrobe for luggage and clothes hangers.

### SUMMARY OF THE DISCLOSURE

An embodiment of the disclosure meets the needs presented above by generally comprising a base that may be rolled along a support surface. The base has a slidably adjustable width. The base may support an object thereby facilitating the object to be moved. A plurality of wheels is provided and each of wheels is removably coupled to and extends downwardly from the base. Each of the wheels rolls along the support surface. A pair of arches is provided and each of the arches is removably coupled to the base. A horizontal member is removably coupled between the arches. Thus, objects may be suspended from the horizontal member.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a collapsible cart assembly according to an embodiment of the disclosure.

FIG. 2 is a right side view of an embodiment of the disclosure.

FIG. 3 is a front view of an embodiment of the disclosure.

FIG. 4 is an exploded perspective view of an embodiment of the disclosure.

FIG. 5 is an exploded top perspective view of an embodiment of the disclosure.

### DESCRIPTION OF THE PREFERRED EMBODIMENT

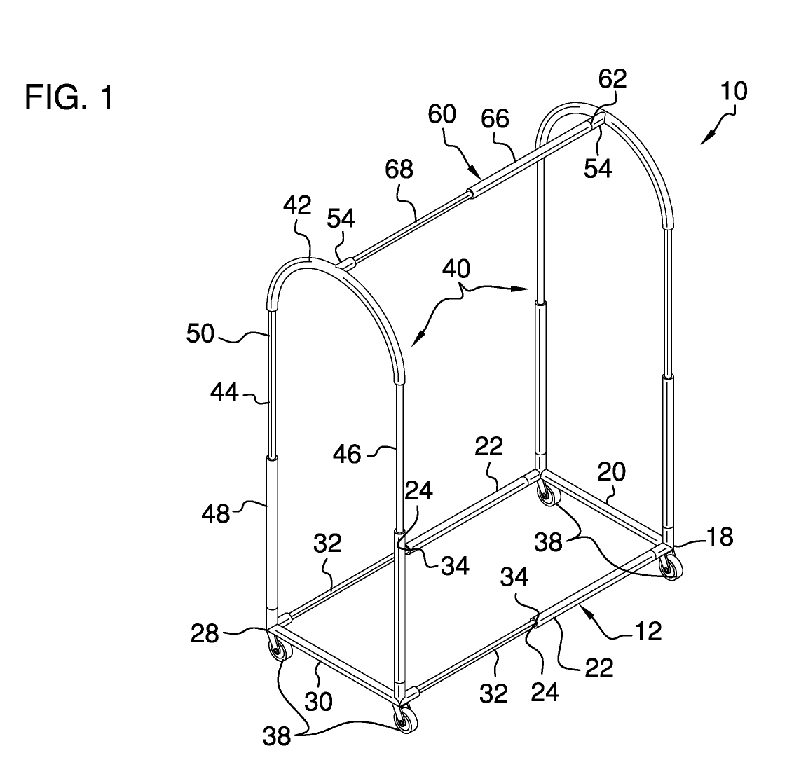

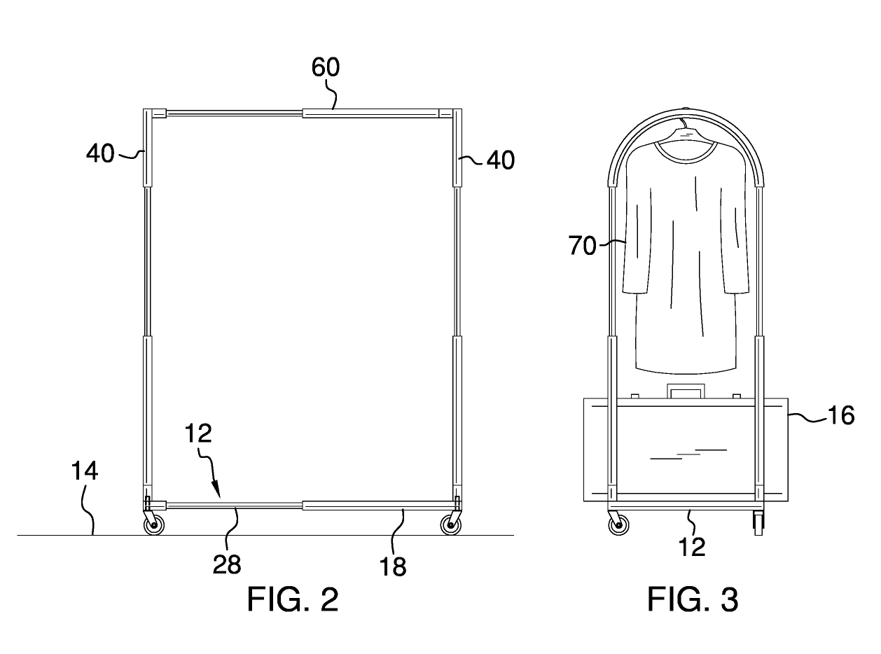

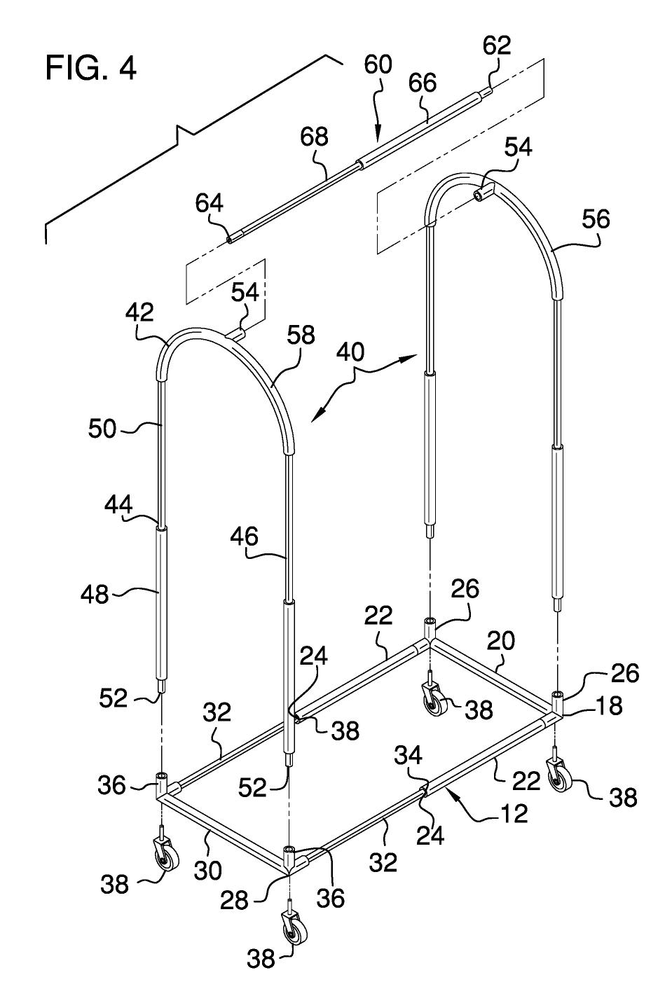

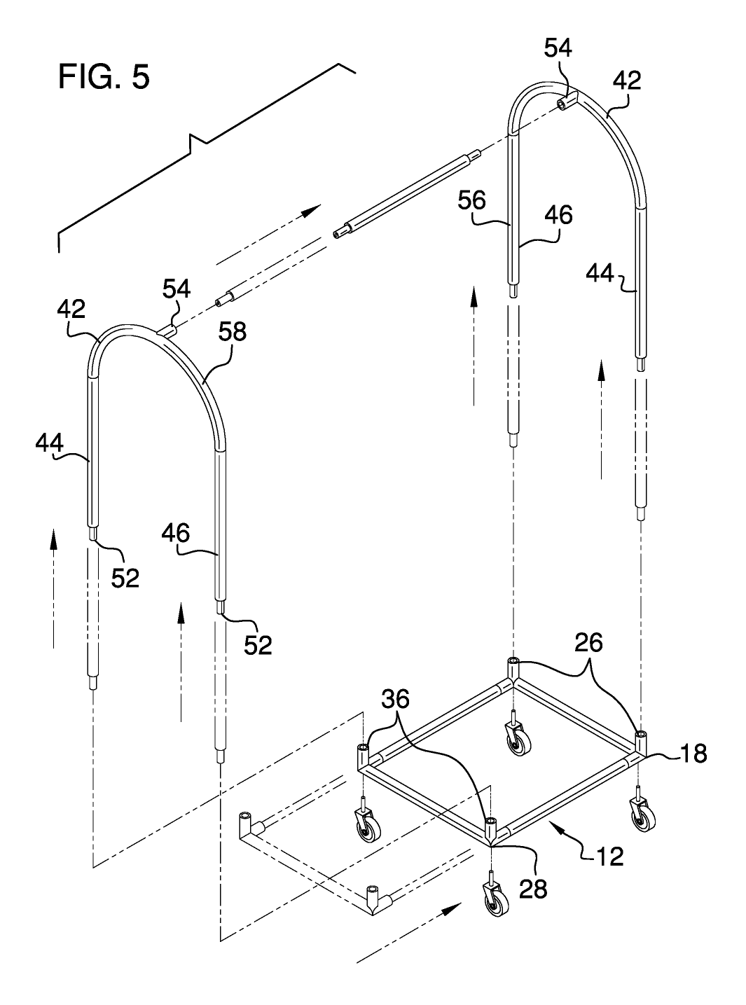

With reference now to the drawings, and in particular to FIGS. 1 through 5 thereof, a new cart device embodying the principles and concepts of an embodiment of the disclosure and generally designated by the reference numeral 10 will be described.

As best illustrated in FIGS. 1 through 5, the collapsible cart assembly 10 generally comprises a base 12 that may be rolled along a support surface 14. The base 12 has a slidably adjustable width. The base 12 may support an object 16 thereby facilitating the object 16 to be moved. The object 16 may be a suitcase or the like.

The base 12 comprises a first frame 18 that has a central member 20 extending between a pair of lateral members 22. The lateral members 22 are spaced apart from each other. Each of the lateral members 22 has a distal end 24 with respect to the central member 20. The distal end 24 of each of the lateral members 22 is open. The first frame 18 has a pair of first receivers 26. Each of the first receivers 26 extends upwardly from an associated intersection of the central member 20 and the lateral members 22.

A second frame 28 is provided. The second frame 28 has a middle member 30 extending between a pair of side members 32. The side members 32 are spaced apart from each other. Each of the side members 32 has a distal end 34 with respect to the middle member 30.

The distal end 24 of each of the lateral members 22 insertably receives the distal end 34 of an associated side member 32. Thus, the second frame 28 is slidably coupled to the first frame 18. The second frame 28 has a pair of second receivers 36. Each of the second receivers 36 extends upwardly from an associated intersection of the middle 30 member and the side members 32.

A plurality of wheels 38 is provided. Each of wheels 38 is removably coupled to and extends downwardly from the base 12. Thus, each of the wheels 38 may roll along the support surface 14. Each of the wheels 38 may be distributed around four corners of the base 12.

A pair of arches 40 is provided. Each of the arches 40 includes a medial portion 42 extending between a first leg 44 and a second leg 46. Each of the first leg 44 and the second leg 46 has a bottom portion 48 that is slidably coupled to a top portion 50. Thus, each of the first leg 44 and the second leg 46 has a telescopically adjustable length. Each of the first leg 44 and the second leg 46 has a bottom end 52. Each of the arches 40 has a sleeve 54 extending laterally away from the medial portion 42.

The pair of arches 40 includes a first arch 56 and a second arch 58. Each of the first receivers 26 insertably receives the bottom end 52 of an associated first leg 44 and an associated second leg 46 corresponding to the first arch 56. Each of the second receivers 36 insertably receives the bottom end 52 of an associated first leg 44 and an associated second leg 46 corresponding to the second arch 58. Thus, each of the arches 40 is removably coupled to the base 12.

A horizontal member 60 is provided. The horizontal member 60 has a first end 62 and a second end 64. Moreover, the horizontal member 60 has a first half slidably 66 coupled to a second half 68. Thus, the horizontal member 60 has a slidably adjustable length. The sleeve 54 on each of the arches 40 insertably receives an associated one of the first end 62 and the second end 64. Thus, objects 70 may be suspended from the horizontal member 60. The objects 70 may be clothes hangers or the like.

In use, the first frame 18 is slidably coupled to the second frame 28 and each of the wheels 38 is coupled to the base 12. The wheels 38 are positioned on the support surface 14. The first arch 58 and the second arch 60 are coupled to the base 12. The horizontal member 60 is coupled between each of the arches 40. The objects 70 are suspended from the horizontal member 60. The base 12, arches 40 and horizontal member 60 are carried during air travel or the like. Thus, the base 12, arches 40 and horizontal member 60 are assembly at a destination thereby facilitating portable luggage transportation and clothes hanging.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A collapsible cart assembly comprising:
a base being configured to be rolled along a support surface, said base having a slidably adjustable width, said base being configured to support an object thereby facilitating the object to be moved;
a plurality of wheels, each of wheels being removably coupled to and extending downwardly from said base, each of said wheels being configured to roll along the support surface;
a pair of arches, each of said arches being removably coupled to said base; and
a horizontal member being removably coupled between said arches wherein said horizontal member is configured to have objects suspended therefrom, said horizontal member having a first end and a second end, said horizontal member having a first half being slidably coupled to a second half such that said horizontal member has a slidably adjustable length.

2. The assembly according to claim 1, wherein said base comprises a first frame having a central member extending between a pair of lateral members, said lateral members being spaced apart from each other, each of said lateral members having a distal end with respect to said central member, said distal end of each of said lateral members being open, said first frame having a pair of first receivers, each of said first receivers extending upwardly from an associated intersection of said central member and said lateral members.

3. The assembly according to claim 2, further comprising a second frame having a middle member extending between a pair of side members, said side members being spaced apart from each other, each of said side members having a distal end with respect to said middle member, said distal end of each of said lateral members insertably receiving said distal end of an associated side member such that said second frame is slidably coupled to said first frame, said second frame having a pair of second receivers, each of said second receivers extending upwardly from an associated intersection of said middle member and said side members.

4. The assembly according to claim 1 wherein each of said arches has a medial portion extending between a first leg and a second leg, each of said first leg and said second leg having a bottom portion being slidably coupled to a top portion such that each of said first leg and said second leg has a telescopically adjustable length, each of said first leg and said second leg having a bottom end, each of said arches having a sleeve extending laterally away from said medial portion.

5. The assembly according to claim 4, wherein:
said base includes a pair of first receivers and a pair of second receivers; and
said pair of arches includes a first arch and a second arch, each of said first receivers insertably receiving said bottom end of an associated first leg and an associated second leg corresponding to said first arch, each of said second receivers insertably receiving said bottom end of an associated first leg and an associated second leg corresponding to said second arch.

6. The assembly according to claim 4, wherein said sleeve on each of said arches insertably receives an associated one of said first end and said second end.

7. A collapsible cart assembly comprising:
a base being configured to be rolled along a support surface, said base having a slidably adjustable width, said base being configured to support an object thereby facilitating the object to be moved, said base comprising:
a first frame having a central member extending between a pair of lateral members, said lateral members being spaced apart from each other, each of said lateral members having a distal end with respect to said central member, said distal end of each of said lateral members being open, said first frame having a pair of first receivers, each of said first receivers extending upwardly from an associated intersection of said central member and said lateral members,
a second frame having a middle member extending between a pair of side members, said side members being spaced apart from each other, each of said side members having a distal end with respect to said middle member, said distal end of each of said lateral members insertably receiving said distal end of an associated side member such that said second frame is slidably coupled to said first frame, said second frame having a pair of second receivers, each of said second receivers extending upwardly from an associated intersection of said middle member and said side members, and
a plurality of wheels, each of wheels being removably coupled to and extending downwardly from said base, each of said wheels being configured to roll along the support surface;
a pair of arches, each of said arches having a medial portion extending between a first leg and a second leg, each of said first leg and said second leg having a bottom portion being slidably coupled to a top portion such that each of said first leg and said second leg has a telescopically adjustable length, each of said first leg and said second leg having a bottom end, each of said arches having a sleeve extending laterally away from said medial portion, said pair of arches including a first arch and a second arch, each of said first receivers insertably receiving said bottom end of an associated first leg and an associated second leg corresponding to said first arch, each of said second receivers insertably receiving said bottom end of an associated first leg and an associated second leg corresponding to said second arch; and
a horizontal member having a first end and a second end, said horizontal member having a first half being slidably coupled to a second half such that said horizontal member has a slidably adjustable length, said sleeve on each of said arches insertably receiving an associated one of said first end and said second end wherein said horizontal member is configured to have objects suspended therefrom.
